(19) United States
(12) Patent Application Publication
(10) Pub. No.: US 2026/0312620 A1
(43) Pub. Date: Oct. 8, 2026

(54) METHOD AND APPARATUS FOR ROUND HOPPING IN HYPER BLOCK FOR ULTRA-WIDEBAND COMMUNICATION

(71) Applicant: Samsung Electronics Co., Ltd., Suwon-si, Gyeonggi-do (KR)

(72) Inventors: Youngwan SO, Suwon-si (KR); Mingyu LEE, Suwon-si (KR); Taeyoung HA, Suwon-si (KR)

(21) Appl. No.: 19/483,061

(22) PCT Filed: May 10, 2024
(86) PCT No.: PCT/EP2024/006413

§ 371 Date: Nov. 10, 2025

(30) Foreign Application Priority Data
May 12, 2023 (KR) 10-2023-0062041

(51) Int. Cl. H04B 1/7163; G01S 13/02; G01S 13/76

(52) U.S. Cl. CPC H04B 1/71632; G01S 13/0209; G01S 13/765

(57) ABSTRACT

The present disclosure relates to a first ultra-wideband (UWB) device supporting a hyper block including at least one ranging block. A method of a first ultra-wideband (UWB) device according to an embodiment of the present disclosure may comprise the steps of generating a control message including an index of a ranging round, an offset of the ranging round, and an index of a hyper block, transmitting the control message to a second UWB device, and performing round hopping between ranging rounds on the basis of the index of the hyper block. Various other embodiments may be included.

### CROSS-REFERENCE TO RELATED APPLICATION(S)

This application is a U.S. National Stage application under 35 U.S.C. §371 of an International application number PCT/KR2024/006413, filed on May 10, 2024, which is based on and claims priority of a Korean patent application number 10-2023-0062041, filed on May 12, 2023, in the Korean, the disclosure of which is incorporated by reference herein in its entirety.

### TECHNICAL FIELD

The disclosure relates to UWB communication, and more particularly, to a method and device for round hopping in a hyper block for UWB communication.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create a new value in human life. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wideband (UWB).

### DETAILED DESCRIPTION OF THE INVENTION

### Technical Problem

The disclosure provides a method for setting round hopping in a hyper block during UWB communication.

### Technical Solution

According to an embodiment of the disclosure, a method of a first ultra-wideband (UWB) device supporting a hyper block may include generating a control message including an index of a ranging round, an offset of the ranging round, and an index of a hyper block, transmitting the control message to a second UWB device, and performing round hopping between ranging rounds based on the index of the hyper block.

According to an embodiment of the disclosure, a method of a first ultra-wideband (UWB) device supporting a hyper block may include generating a control message including configuration information for a hyper block structure and an indicator regarding whether round hopping is applied, transmitting the control message to a second UWB device, and performing round hopping between ranging rounds based on the indicator regarding whether round hopping is applied.

According to an embodiment of the disclosure, a first ultra-wideband (UWB) device supporting a hyper block includes a transceiver, and a controller. The controller may generate a control message including an index of a ranging round, an offset of the ranging round, and an index of a hyper block, control to transmit the control message to a second UWB device, and perform round hopping between ranging rounds based on the index of the hyper block.

According to an embodiment of the disclosure, a first ultra-wideband (UWB) device supporting a hyper block includes a transceiver, and a controller. The controller may generate a control message including configuration information for a hyper block structure and an indicator regarding whether round hopping is applied, control to transmit the control message to a second UWB device, and perform round hopping between ranging rounds based on the indicator regarding whether round hopping is applied.

### Advantageous Effects

The method and device according to an embodiment of the disclosure may efficiently perform round hopping in a hyper block structure where the length of each ranging round is not constant.

### BRIEF DESCRIPTION OF DRAWINGS

FIG. 1 illustrates an example architecture of a UWB device according to an embodiment of the disclosure.

FIG. 2 illustrates a structure of a UWB MAC frame according to an embodiment of the disclosure.

FIG. 3 illustrates a structure of a UWB PHY packet according to an embodiment of the disclosure.

FIG. 4 illustrates an example of a structure of a ranging block and round used for UWB ranging according to an embodiment of the disclosure.

FIG. 5 illustrates a ranging block structure to which a block-based mode is applied according to an embodiment of the disclosure.

FIG. 6A illustrates an advanced ranging control (ARC) information element (IE) including information for configuring a time block structure according to an embodiment of the disclosure.

FIG. 6B illustrates a ranging block update (RBU) IE including information for updating a time block structure according to an embodiment of the disclosure.

FIG. 7 illustrates an example of a hyper block structure according to an embodiment of the disclosure.

FIG. 8 illustrates an example of round hopping according to an embodiment of the disclosure.

FIG. 9 illustrates a ranging round (RR) IE according to an embodiment of the disclosure.

FIGS. 10A and 10B illustrate an example of round hopping in a hyper block according to an embodiment of the disclosure.

FIG. 11 illustrates an RR IE according to another embodiment of the disclosure.

FIG. 12 illustrates an example of round hopping in a hyper block according to another embodiment of the disclosure.

FIG. 13A illustrates an example of a Hyper Block Structure (HBS) IE according to an embodiment of the disclosure.

FIG. 13B illustrates an example of an HBS IE and round hopping in a hyper block according to an embodiment of the disclosure.

FIG. 14A illustrates an example of an HBS IE according to an embodiment of the disclosure.

FIG. 14B illustrates an example of an HBS IE and round hopping in a hyper block according to an embodiment of the disclosure.

FIG. 15A illustrates an example of round hopping, and FIG. 15B illustrates an example of block hopping according to an embodiment of the disclosure.

FIG. 16 illustrates another example of block hopping according to an embodiment of the disclosure.

FIG. 17 illustrates a structure of a UWB device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “. . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. Further, although a communication system using UWB is described in connection with embodiments of the present invention, as an example, embodiments of the present invention may also apply to other communication systems with similar technical background or features. For example, a communication system using Bluetooth or ZigBee may be included therein. Further, embodiments of the present invention may be modified in such a range as not to significantly depart from the scope of the present invention under the determination by one of ordinary skill in the art and such modifications may be applicable to other communication systems.

When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wideband (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Ranging device” may be a device capable of performing UWB ranging. In the disclosure, the ranging device may be a ranging device (RDEV) or enhanced ranging device (ERDEV) defined in, e.g., IEEE 802.15.4/4z. In the disclosure, the ranging device may be referred to as a UWB device.

“Advertiser” may be a device (e.g., ranging device) that transmits (or broadcasts) an advertisement message through an advertisement channel.

“Scanner” may be a device (e.g., ranging device) that scans an advertisement channel and receives an advertisement message. In the disclosure, the scanner may also be referred to as an observer.

“Controller” may be a device (e.g., ranging device) that defines and controls ranging control messages (RCM) (or control messages). The controller may define and control ranging features by transmitting a control message.

“Controlee” may be a device (e.g., ranging device) using a ranging parameter in the RCM (or control message) received from the controller. The controlee may use the same ranging features as those configured through control messages from the controller.

“Initiator” may be a device (e.g., ranging device) that initiates a ranging exchange. The initiator may initiate a ranging exchange by transmitting a first RFRAME (ranging exchange message).

“Responder” may be a device (e.g., ranging device) that responds to the Initiator in a ranging exchange. The responder may respond to the ranging exchange message received from the initiator.

“In-band” may be data communication that uses UWB as an underlying wireless technology.

“Out-of-band (OOB)” may be data communication that does not use UWB as an underlying wireless technology.

“UWB Session” may be a period from when the controller and the controlee start communication through UWB until the communication stops. In the UWB session, a ranging frame RFRAME may be transferred, a data frame may be transferred, or both a ranging frame and a data frame may be transferred.

“UWB session ID” may be an ID (e.g., a 32-bit integer) that identifies the UWB session, shared between the controller and the controlee.

“UWB session key” may be a key used to protect the UWB Session. The UWB session key may be used to generate a scrambled timestamp sequence (STS). In this disclosure, the UWB session key may be a UWB ranging session key (URSK), and may be abbreviated as a session key.

“UWB subsystem (UWBS)” may be a hardware component implementing the UWB PHY and MAC specifications included in the UWB device. In this disclosure, the UWB PHY and MAC specifications may be, e.g., the PHY and MAC specifications defined in, e.g., IEEE 802.15.4/4z. In this disclosure, the UWBS may be referred to as a UWB component.

“UWB-enabled application” may be an application for a service (UWB service). In this disclosure, “UWB-enabled Application” may be abbreviated as an application or a UWB application.

“Service” may be an implementation of a use case that provides a service to an end-user. In this disclosure, the service may be referred to as a UWB service.

“Service data” may be data defined by a service provider that needs to be transferred between two ranging devices to implement a service.

“Service provider” may be an entity that defines and provides hardware and software required to provide a specific service to an end-user.

“STS” may be a ciphered sequence for increasing the integrity and accuracy of ranging measurement timestamps.

Unlike “static STS,” “dynamic STS mode” may be an operation mode in which the STS is not repeated during a ranging session. In this mode, the STS may be managed by the ranging device, and the ranging session key for generating STS may be managed by a secure component.

“Static STS mode” is an operation mode in which STS is repeated during a session, and does not need to be managed by the Secure Component.

“Secure channel” may be a data channel that prevents overhearing and tampering.

“Secure component” may be an entity (e.g., secure element (SE) or trusted execution environment (TEE)) having a defined security level that interfaces with UWBS for the purpose of providing RDS to UWBS, e.g., when dynamic STS is used.

“Secure ranging” may be ranging based on STS generated through a strong encryption operation.

When determined to make the subject matter of the present invention unnecessarily unclear, the detailed description of related known functions or features may be skipped in describing the disclosure.

Hereinafter, various embodiments of the disclosure are described with reference to the accompanying drawings.

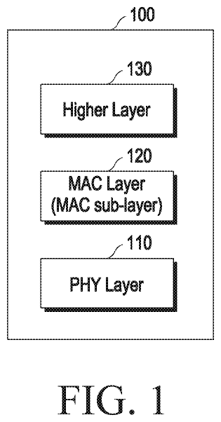

FIG. 1 illustrates an example architecture of a UWB device according to an embodiment of the disclosure.

Referring to FIG. 1, the UWB device 100 may include at least one PHY layer 110, a MAC layer (MAC sublayer) 120, and/or a higher layer 130. In the disclosure, the configuration including the PHY layer 110 and the MAC layer 120 may be referred to as UWBS.

### (1) PHY layer

At least one PHY layer 110 may include a transceiver with a low-level control mechanism. In this disclosure, the transceiver may be referred to as an RF transceiver or a radio transceiver.

In an embodiment, the PHY layer 110 may support at least one of the following functions.
Transceiver activation and deactivation function (transceiver on/off function)
Energy detection function
Channel selection function
Clear channel assessment (CCA) function
Synchronization function
Low-level signaling function
UWB ranging, positioning and localization functions
Spectrum resource management function
Function to transmit/receive packets through physical medium

### (2) MAC layer

The MAC layer 120 provides an interface between the higher layer 130 and the PHY layer 110.

In an embodiment, the MAC layer 120 may provide two services as follows.
MAC data service: A service that enables transmission and reception of MAC protocol data unit (PDU) through the PHY
MAC management service: Service interfacing to MAC sublayer management entity (MLME) service access point (SAP) (MLME-SAP)

In an embodiment, the MAC layer 120 may support at least one of the following functions.
Device discovery and connection setup function
Channel access function (access function for physical channel)
Synchronization function
Interference mitigation function based on energy detection
Functions related to narrowband signaling
Guaranteed timeslot (GTS) management function
Frame delivery function
UWB ranging function
PHY parameter change notification function
Security function

### (3) Upper layer

The upper layer 130 may include a network layer providing functions, such as network configuration and message routing, and/or an application layer providing an intended function of the device.

In an embodiment, the application layer may be a UWB-enabled application layer for providing a UWB service.

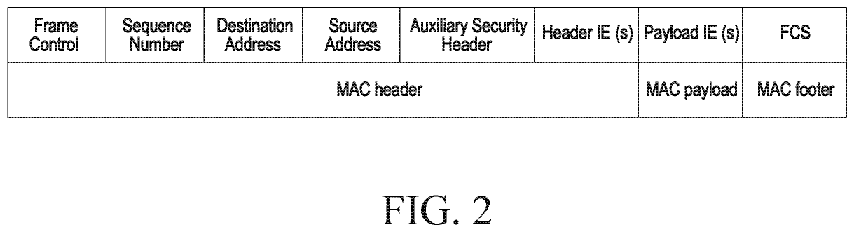

FIG. 2 illustrates a structure of a UWB MAC frame according to an embodiment of the disclosure.

In the embodiment of FIG. 2, the UWB MAC frame may be simply referred to as a MAC frame or frame. As an embodiment, the UWB MAC frame may be used to transfer UWB data (e.g., UWB message, ranging message, control information, service data, application data, transaction data, etc.).

Referring to FIG. 2, the UWB MAC frame may include a MAC header (MHR), a MAC payload and/or a MAC footer (MFR).

### (1) MAC Header

The MAC header may include a Frame Control field, a Sequence Number field, a Destination Address field, a Source Address field, an Auxiliary Security Header field, and/or at least one Header IE field. According to an embodiment, some of the above-described fields may not be included in the MAC header, and additional field(s) may be further included in the MAC header.

In an embodiment, the Frame Control field may include a Frame type field, a Security Enabled field, a Frame Pending field, an AR field, a PAN ID Compression field, a Sequence Number Suppression field, an IE Present field, a Destination Addressing Mode field, a Frame Version field, and/or a Source Addressing Mode field. According to an embodiment, some of the above-described fields may not be included in the Frame Control field. Additional field(s) may be further included in the Frame Control field.

Each field is described below.

The Frame Type field may indicate the frame type. As an embodiment, the frame type may include a data type and/or a multipurpose type.

The Security Enabled field may indicate whether an Auxiliary Security Header field exists. The Auxiliary Security Header field may include information required for security processing.

The Frame Pending field may indicate whether the device transmitting the frame has more data for the recipient. In other words, the Frame Pending field may indicate whether there is a pending frame for the recipient.

The AR field may indicate whether acknowledgment for frame reception is required from the recipient.

The PAN ID Compression field may indicate whether the PAN ID field exists.

The Sequence Number Suppression field may indicate whether the Sequence Number field exists. The Sequence Number field may indicate the sequence identifier for the frame.

The IE Present field may indicate whether the Header IE field and the Payload IE field are included in the frame.

The Destination Addressing Mode field may indicate whether the Destination Address field may include a short address (e.g., 16 bits) or an extended address (e.g., 64 bits). The Destination Address field may indicate the address of the recipient of the frame.

The Frame Version field may indicate the frame version. For example, the Frame Version field may be set to a value indicating IEEE std 802.15.4z-2020.

The Source Addressing Mode field may indicate whether the Source Address field exists, and if the Source Address field exists, whether the Source Address field includes a short address (e.g., 16 bits) or an extended address (e.g., 64 bits). The Source Address field may indicate the address of the originator of the frame.

### (2) MAC Payload

The MAC payload may include at least one Payload IE field. In an embodiment, the Payload IE field may include a Vendor Specific Nested IE. In an embodiment, the Payload IE field may include at least one IE for configuring or changing (updating) the time block structure.

### (3) MAC Footer

The MAC footer may include an FCS field. The FCS field may include a 16-bit CRC or a 32-bit CRC.

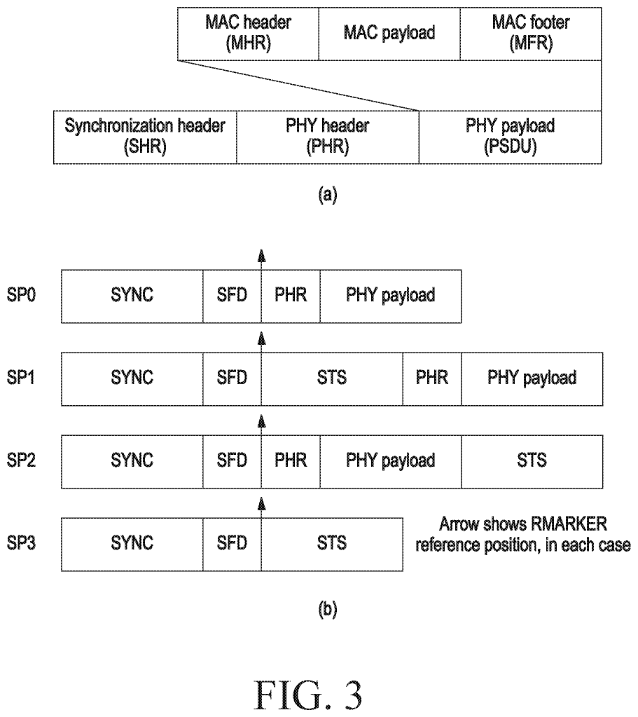

FIG. 3 illustrates a structure of a UWB PHY packet according to an embodiment of the disclosure.

FIG. 3(a) illustrates an example structure of a UWB PHY packet to which the STS packet configuration is not applied, and FIG. 3(b) illustrates an example structure of a UWB PHY packet to which the STS packet configuration is applied. In the disclosure, the UWB PHY packet may be referred to as a PHY packet, a PHY PDU (PPDU), or a frame.

Referring to FIG. 3(a), the PPDU may include a synchronization header (SHR), a PHY header (PHR), and a PHY payload (PSDU). The PSDU may include a MAC frame. As shown in FIG. 2, the MAC frame may include a MAC header (MHR), a MAC payload and/or a MAC footer (MFR). In the disclosure, the synchronization header part may be referred to as a preamble, and the part including the PHY header and the PHY payload may be referred to as a data part.

The synchronization header may be used for synchronization for signal reception and may include a SYNC field and a start-of-frame delimiter (SFD).

The SYNC field may be a field including a plurality of preamble symbols used for synchronization between transmission/reception devices. The preamble symbol may be set through one of previously defined preamble codes.

The SFD field may be a field indicating the end of the SHR and the start of the data field.

The PHY header may provide information about the configuration of the PHY payload. For example, the PHY header may include information about the length of the PSDU, information indicating whether the current frame is an RFRAME (or Data Frame), and the like.

Meanwhile, the PHY layer of the UWB device may include an optional mode to provide a reduced on-air time for high density/low power operation. In this case, the UWB PHY packet may include an encrypted sequence (i.e., STS) to increase the integrity and accuracy of the ranging measurement timestamp. An STS may be included in the STS field of the UWB PHY packet and be used for secure ranging.

Referring to FIG. 3(b), in the case of STS packet (SP) setting 0 (SP0), the STS field is not included in the PPDU (SP0 packet). In the case of SP setting 1 (SP1), the STS field is positioned immediately after the Start of Frame Delimiter (SFD) field and before the PHR field (SP1 packet). In the case of SP setting 2 (SP2), the STS field is positioned after the PHY payload (SP2 packet). In the case of SP setting 3 (SP3), the STS field is positioned immediately after the SFD field, and the PPDU does not include the PHR and data field (PHY payload) (SP3 packet). In other words, in the case of SP3, the PPDU does not include the PHR and PHY payload.

In the embodiment of FIG. 3(b), each UWB PHY packet may include RMARKER for defining a reference time. RMARKER may be used to obtain the transmission time, reception time and/or time range of the ranging message (frame) in the UWB ranging procedure.

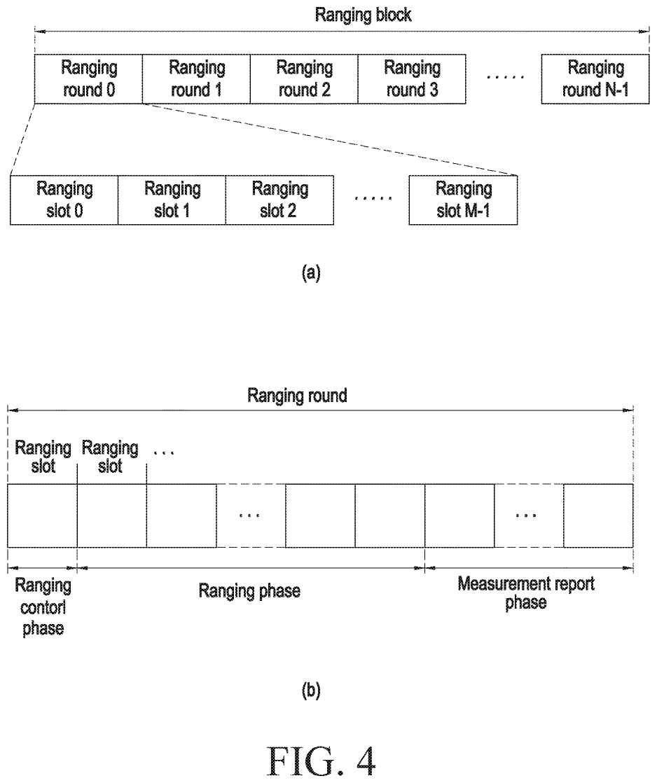

FIG. 4 illustrates an example of a structure of a ranging block and round used for UWB ranging according to an embodiment of the disclosure.

In this disclosure, the ranging block refers to a time period for ranging. The ranging round may be a period of sufficient duration to complete one entire range-measurement cycle (ranging cycle) in which a set of ranging devices participating in a ranging exchange involves. The ranging slot may be a sufficient period for transmission of at least one ranging frame (RFRAME) (e.g., ranging initiation/reply/final message, etc.).

When the ranging mode is a block-based mode, a mean time between contiguous ranging rounds may be a constant. Alternatively, when the ranging mode is an interval-based mode, the time between contiguous ranging rounds may be dynamically changed. In other words, the interval-based mode may adopt a time structure having an adaptive spacing.

Referring to FIG. 4(a), one ranging block may include at least one ranging round. Each ranging round may include at least one ranging slot. For example, as shown, one ranging block may include N ranging rounds, and ranging round #0 may include M ranging slots.

In the disclosure, the ranging block may be abbreviated as a block, the ranging round as a round, and the ranging slot as a slot.

Referring to FIG. 4(b), one ranging round may include a ranging control phase, a ranging phase, and/or a measurement report phase. For example, as shown, one ranging round may include one slot for the ranging control phase, at least one slot for the ranging phase, and/or at least one slot for the measurement report phase. According to an embodiment, some of the above-described phases may not be included in the ranging round. Additional phases (e.g., ranging control update phase, or ranging interval update phase) may be further included in the ranging round.

The ranging control phase (RCP) may be a phase in which the controller transmits a ranging control message (RCM). The RCM may be a message transmitted by the controller to set ranging parameters. The RCM may be transmitted in the first slot (slot #0) of the ranging round.

The ranging phase may include a ranging initiation phase, a ranging response phase, and/or a ranging final phase.

The ranging initiation phase (RIP) may be a phase in which initiator(s) transmit ranging initiation message(s) to responder(s).

The ranging response phase (RRP) may be a phase in which the responder(s) transmit their response message(s) to the initiator.

The ranging final phase (RFP) may be a phase in which the initiator transmits final message(s) to responder(s). The ranging final phase may only be used for DS-TWR.

The measurement report phase (MRP) may be a phase in which participating ranging devices exchange service information related to ranging measurement.

The ranging control update phase (RCUP) may be a phase in which the controller transmits a ranging control update message (RCUM). The ranging control update phase may be included in the last slot of the set of ranging rounds designated by the RCM. The RCUM may be a message transmitted by the controller to update ranging parameters for the next ranging round(s). The RCUM may be transmitted in the last slot of the ranging round(s) designated by the RCM. The RCUM may include some or all of the information elements (IEs) employed by the RCM to update the values of parameters.

The ranging interval update phase (RIUP) may be a phase in which the controller transmits a ranging interval update message (RIUM). The RIUM may be a message transmitted by the controller to help synchronization between participating ranging devices or to update the interval between ranging blocks. The RIUM includes the scheduled time of the first RIUM. The RIUM may include the scheduled time of the next RIUM before the next ranging block starts.

In an embodiment, the controller may transmit an RCM including information (block configuration information) for configuring a time block structure, and the controller may configure the time block structure based on the block configuration information included in the RCM.

In an embodiment, the RCM may include the length (duration) of the ranging block, the length of the ranging round, and/or the length of the ranging slot. The RCM may include information about the device role of the ranging device.

In an embodiment, the controller may transmit the RCM on a per-round basis. For example, the controller may transmit the RCM in all or some of the ranging rounds in the ranging block. For example, the controller may transmit the RCM in ranging round #0 and ranging round #2 in the ranging block.

In an embodiment, the controller may transmit the RCM in the first slot (slot index 0) of the corresponding ranging round.

In an embodiment, the information (parameter) included in the RCM may be applied to the round(s) (e.g., one or more subsequent rounds) after the round (current round) in which the RCM is received.

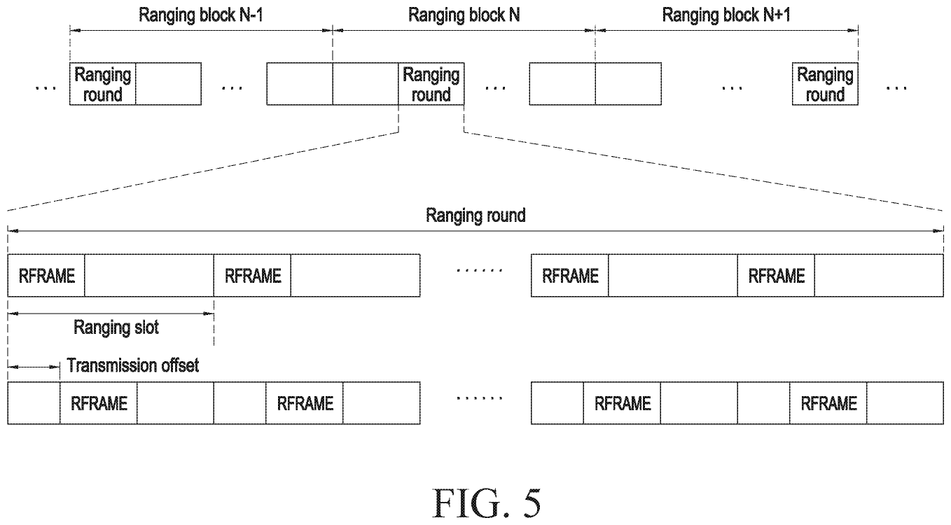

FIG. 5 illustrates a ranging block structure to which a block-based mode is applied according to an embodiment of the disclosure.

As shown in FIG. 5, the block-based mode uses a structured timeline in which the ranging block structure is basically periodical. In the block-based mode, a mean time between consecutive ranging rounds may be a constant. Also, in the block-based mode, the same block structure may be repeated.

In an embodiment, in the block-based mode, the ranging block structure may be configured by designating a ranging block length (duration) field, a ranging round length field, and a ranging slot length field in the advanced ranging control (ARC) IE.

In an embodiment, in the block-based mode, the number of ranging rounds may be obtained by dividing the ranging block length (duration) by the ranging round length, and the number of ranging slots may be obtained by dividing the ranging round length by the ranging slot length.

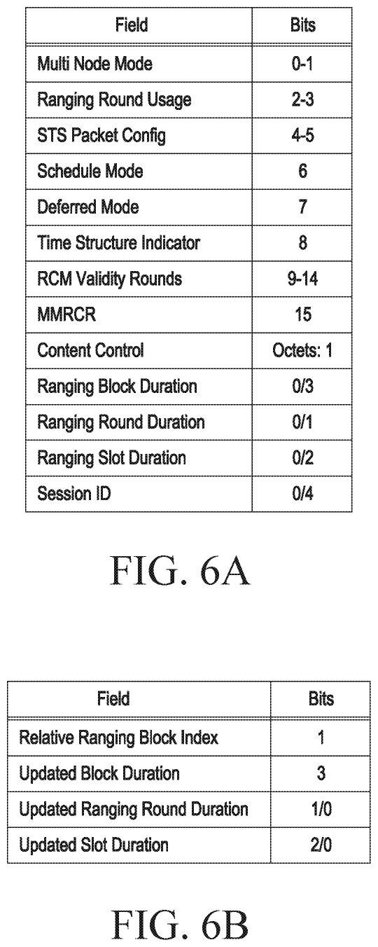

FIG. 6A illustrates an ARC IE including information for configuring a time block structure according to an embodiment of the disclosure.

In an embodiment, the ARC IE may be used by the controller to transmit ranging configuration information to a controlee (unicast case) or a plurality of controlees (broadcast case). In this case, the ACE IE may be included in the RCM and transmitted.

In an embodiment, the ARC IE may be used by the controlee to transmit preferred ranging parameters to the controller. In this case, the ARC IE may be transmitted together with a ringing change request (RCR) IE.

In an embodiment, the ARC IE may be transmitted through the payload IE field of the MAC frame.

In an embodiment, the ARC IE may be included in the RCM.

In an embodiment, the ARC IE may be used for initial setting of a time block structure (block/round/slot structure).

Referring to FIG. 6A, the ARC IE (or the content field of the ARC IE) may include a Multi Node Mode field, a Ranging Round Usage field, an STS Packet Config field, a Schedule Mode field, a Deferred Mode field, a Time Structure Indicator field, an RCM Validity Rounds field, a Multiple Message Receipt Confirmation Request (MMRCR) field, a Content Control field, a Ranging Block Duration field, a Ranging Round Duration field, a Ranging Slot Duration field, and/or a Session ID field. According to an embodiment, some of the above-described fields may not be included in the ARC IE, or additional fields may be further included in the ARC IE.

The Multi Node Mode field may specify whether ranging is performed between a single pair of devices or is multi-node ranging involving a plurality of devices.

The Ranging Round Usage field may specify the use of the current ranging round and a consecutive number of ranging round(s) following the RCM, as designated in the RCM Validity Rounds field of the ARC IE.

The STS Packet Config field may specify the STS packet format to be used in the ranging round(s) following the ARC IE.

The Schedule Mode field may specify whether scheduling-based ranging or contention-based ranging is performed.

The Deferred Mode field may specify whether or not a Deferred frame is allowed for a measurement report. When the value of the Deferred Mode field is 1, the Deferred Mode field may indicate that the ranging slot is scheduled to exchange the Deferred data frame(s) after the ranging cycle. The Deferred data frame(s) may be used to report measurement information such as ToF, reply time, and AoA. When the value of the Deferred Mode field is 0, the Deferred Mode field may indicate that the ranging slot is not scheduled for the data frame(s) for exchanging the requested information.

The Time Structure Indicator field may specify the ranging time structure behavior in following ranging rounds.

The RCM Validity Rounds field may specify the number of consecutive ranging rounds controlled by the RCM. The value of the RCM Validity Rounds field may not be greater than the number of remaining ranging blocks in the current ranging block.

The MMRCR field may specify whether multiple message receipt acknowledgment is requested. When the value of the MMRCR field is 1, multiple message reception confirmation is requested and, otherwise, multiple message reception confirmation is not requested.

The Content Control field may indicate the presence or absence of other fields in the ARC IE.

The Ranging Block Duration field may specify the duration of a ranging block in RSTU units.

The Ranging Round Duration field may specify the duration of a ranging round in units of ranging slots.

The Ranging Slot Duration field may specify the duration of a ranging slot in RSTU units.

The Session ID field may specify the identifier of the ranging session. The Session ID field may include a unique 4-octet session identifier in a session for each controller. The ranging session may include one controller and at least one initiator.

FIG. 6B illustrates a ranging block update (RBU) IE including information for updating a time block structure according to an embodiment of the disclosure.

In an embodiment, the RBU IE may be transmitted to the controlee by the controller to signal an update of the ranging block structure. When the final message in the ranging message sequence is transmitted by the controller, the RBU IE may be included in the final message. However, when the final message in the ranging message sequence is transmitted by the controlee, the RBU IE may be transmitted by the controlee in the next RCM.

In an embodiment, the RBU IE may be transmitted through the payload IE field of the MAC frame. In an embodiment, the RBU IE may be included in the RCM. In an embodiment, the RBU IE may be used to update or change the time block structure (block/round/slot structure).

Referring to FIG. 6B, the RBU IE may include a Relative Ranging Block Index field, an Updated Block Duration field, an Updated Ranging Round Duration field, and/or an Updated Slot Duration field. According to an embodiment, some of the above-described fields may not be included in the RBU IE, or additional fields may be further included in the RBU IE.

The Relative Ranging Block Index field may indicate the number of ranging blocks with the current ranging block structure before switching to a new ranging block structure.

The Updated Block Duration field may indicate a new ranging block duration on a per-RTSU basis. The RBU IE may signal the end of the ranging message exchange. In this case, the Updated Block Duration field in the RBU IE may be set to zero.

The Updated Ranging Round Duration field may specify the value of the ranging round duration in the new ranging block structure as an integer multiple of the ranging slot duration.

The Updated Slot Duration field may specify the ranging slot duration value in a new ranging block structure on a per-RTSU basis.

Meanwhile, with the advancement of UWB communication technology, additional functions such as device discovery, high-capacity data transmission, sensing, etc., in addition to ranging, may be extended and provided through UWB communication. In this case, the number of slots required to operate each additional function may also vary for each block/round, and if the length of all blocks is uniformly fixed to the same value, it would inevitably result in very inefficient slot usage.

In embodiments of the disclosure, a Hyper-block structure may be supported as an example of a flexible block structure capable of supporting various services/modes such as ranging, sensing, and high-capacity data transmission. The Hyper-block structure may support a block structure that may be set to various durations, e.g., rather than repetition of blocks with constant duration. According to an embodiment, the Hyper-block structure may support block, round, and/or slot structures that may be set to various durations.

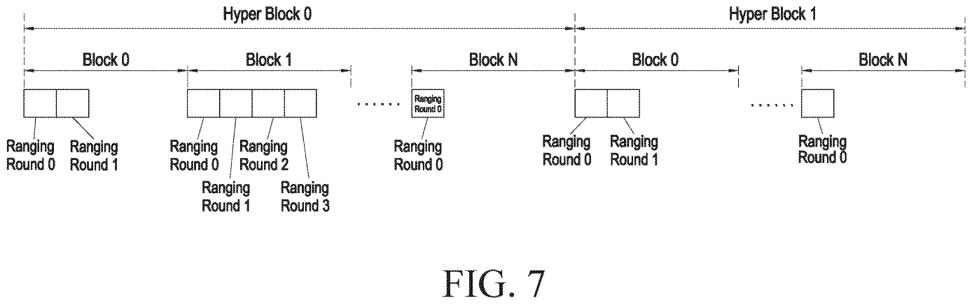

FIG. 7 illustrates an example of a hyper block structure according to an embodiment of the disclosure.

Referring to FIG. 7, consecutive hyper blocks may be configured. For example, as shown in FIG. 7, hyper block #0 and hyper block #1 may be continuously arranged.

Each hyper block may include at least one block. For example, as illustrated in FIG. 7, hyper block #0 may include block #0, block #1, . . . block #N, and hyper block #1 may include block #0, . . . block #N. According to an embodiment, the duration between blocks within a hyper block may be the same or different from each other. In other words, the duration of each block may be freely set according to the configuration. For example, the durations of block #0 and block #1 of hyper block #0 may be set differently from each other.

According to an embodiment, blocks at the same position of hyper block #0 and hyper block #1 may be configured with the same structure and settings. For example, the durations of block #0 of hyper block #0 and block #0 of hyper block #1 may be set identically. For example, the durations of block #1 of hyper block #0 and block #1 of hyper block #1 may be set identically.

Each block may include at least one round. For example, as shown in FIG. 7, in hyper block #0, block #0 may include round #0 and round #1, block #1 may include round #0, round #1, round #2, and round #3, and block #N may include round #0. The durations between rounds in or between blocks may be the same or different from each other. In other words, the duration of each round may be freely set according to the configuration. For example, round #0 and round #1 of block #0 may be set to be different from each other, and round #0 of block #0 and round #0 of block #1 may be set to be different from each other.

Each round may include at least one slot. For example, round #0 of block #0 may include at least one slot. The durations between slots in or between rounds may be the same or different from each other. In other words, the duration of each slot may be freely set according to the configuration.

As described above, in the hyper block structure, durations between hyper blocks, blocks, rounds, and slots may be freely set according to the configuration. In other words, it may have a high degree of freedom.

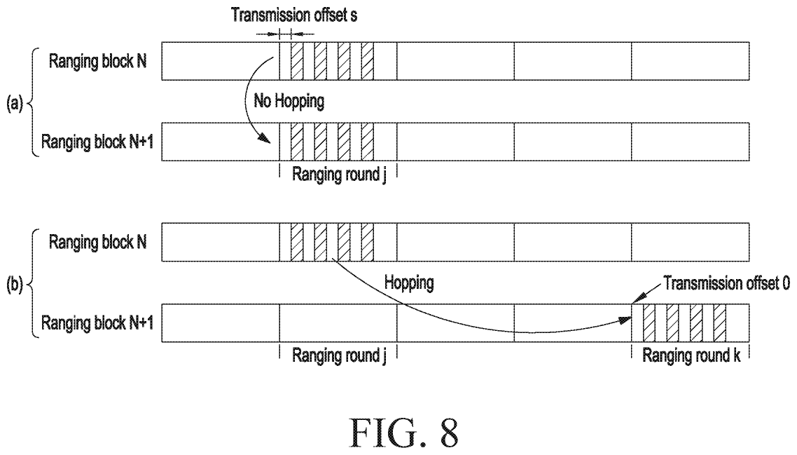

FIG. 8 illustrates an example of round hopping according to an embodiment of the disclosure.

According to an embodiment, to be robust against adjacent interference, etc., round hopping may be used where the round (or ranging round) in which transmission operation is performed is hopped without making the transmission timing constant during the transmission operation of the UWB device.

Referring to FIG. 8(a), the UWB device may be configured not to use a round hopping method (No Hopping). In this case, the UWB device may transmit a message (or packet) based on a first transmission offset s in a first ranging round j within a first ranging block (ranging block N). Subsequently, the UWB device may transmit a message (or packet) based on the first transmission offset s in the first ranging round j within a second ranging block (ranging block N+1) (which is the next block after the first ranging block (ranging block N)). In other words, when the UWB device does not use the round hopping method, it may transmit a message (or packet) in the same ranging round for each ranging block.

Referring to FIG. 8(b), the UWB device may be configured to use a round hopping method (Hopping). In this case, the UWB device may transmit a message (or packet) based on a first transmission offset s in a first ranging round j within a first ranging block (ranging block N). Subsequently, the UWB device may transmit a message (or packet) based on a second transmission offset 0 in a second ranging round k within a second ranging block (ranging block N+1) (which is the next block after the first ranging block (ranging block N)). In other words, when the UWB device uses the round hopping method, it may transmit a message (or packet) based on different ranging rounds and/or transmission offsets for each ranging block.

However, in the hyper block illustrated in FIG. 7, the length of rounds (or ranging rounds) between consecutive adjacent blocks may not be constant, and shuffling may need to be performed between rounds with different durations. In other words, there may be aspects where the round hopping method is difficult to use in the hyper block structure.

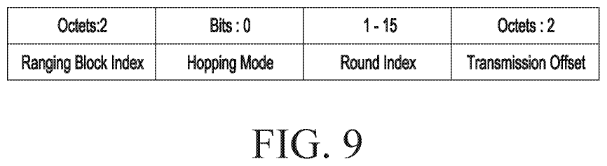

FIG. 9 illustrates a ranging round (RR) IE according to an embodiment of the disclosure.

Referring to FIG. 9, the ranging round (RR) IE may include a Ranging Block Index field, a Hopping Mode field, a Round Index field, and a Transmission Offset field.

The RR IE may indicate scheduling of a ranging round. According to an embodiment, the RR IE may be included in an RCM, a last RFRAME, or a final data message of a ranging message sequence.

According to an embodiment, in a Block-based Mode, the Ranging Block Index field may indicate an index of a ranging block.

According to an embodiment, in a Hyper Block-based Mode, the Ranging Block Index field may indicate an index of a hyper block rather than an index of a ranging block. In this case, a controlee may assume that the same block index as the previous hyper block is used.

According to an embodiment, using the characteristic that the structure between adjacent hyper blocks is the same in the hyper block structure, the UWB device may perform round hopping between ranging blocks at the same position in adjacent hyper blocks rather than adjacent blocks when performing round hopping. In this case, since the index of the ranging block remains unchanged in the next hyper block, the Controller does not need to signal the index of the ranging block to the controlee.

According to an embodiment, since the RR IE is transmitted to all UWB devices participating in the ranging session, the UWB device may perform actual transmission in the round for which hopping is determined. According to an embodiment, an individual slot used by each UWB device during transmission may be determined based on a ranging device management (RDM) IE.

The Hopping Mode field may indicate a hop mode for the ranging block. For example, if the field value is 0, it may indicate no hopping application, and if the field value is 1, it may indicate hopping application.

The Round Index field may specify a ranging round index for the ranging block.

The Transmission Offset field may indicate a transmission offset value of the ranging round within the block in RSTU units. For example, the transmission offset may be a value obtained by subtracting the packet duration from the ranging slot duration.

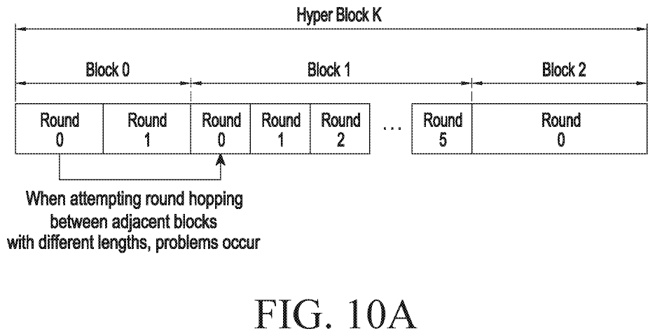

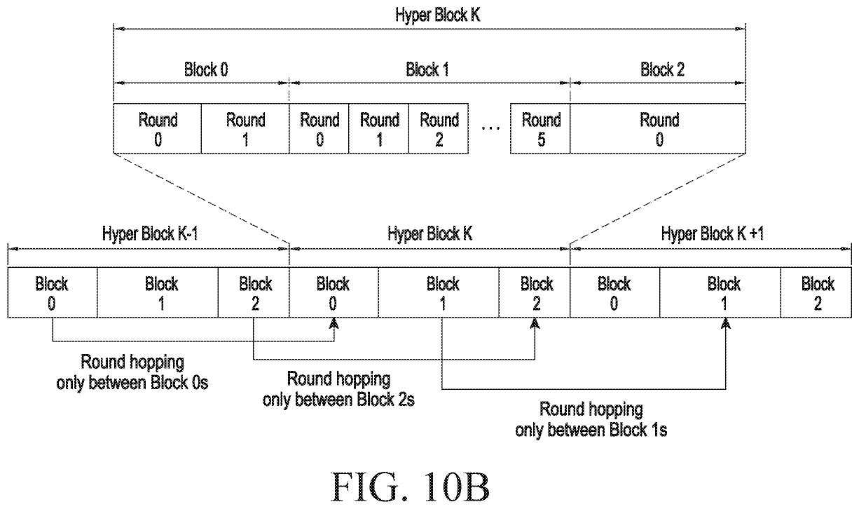

FIGS. 10A and 10B illustrate an example of round hopping in a hyper block according to an embodiment of the disclosure.

Referring to FIGS. 10A and 10B, hyper block #K may include block #0, block #1, and block #2. According to an embodiment, the duration of each block within hyper block #K may be variously set according to configuration. For example, the durations of block #0 and block #1 may be set differently from each other, and the durations of block #0 and block #2 may be set differently from each other. Block #0 may include round #0 and round #1, block #1 may include round #0, round #1, round #2, . . . , round #5, and block #2 may include round #0. According to an embodiment, the duration of each round within each block may be variously set according to configuration. For example, round #0 of block #0 and round #0 of block #1 may be set differently from each other.

In FIG. 10A, when setting round hopping between adjacent blocks with different durations (e.g., round #0 of block #0 and round #0 of block #1), the UWB device may not successfully perform round hopping.

Referring to FIG. 10B, each of adjacent hyper block #K−1, hyper block #K, and hyper block #K+1 may include block #0, block #1, and block #2. According to an embodiment, each of adjacent hyper block #K−1, hyper block #K, and hyper block #K+1 may include the same block structure.

In FIG. 10B, the UWB device may perform round hopping in rounds within blocks at the same position of adjacent hyper blocks by utilizing the characteristic that the same block structure is repeated in adjacent hyper blocks. According to an embodiment, the UWB device may perform round hopping in rounds within blocks at the same position of adjacent hyper blocks based on the RR IE illustrated in FIG. 9.

For example, the UWB device may perform round hopping only between block #0 of hyper block #K−1 and block #0 of hyper block #K. For example, the UWB device may perform round hopping only between block #2 of hyper block #K−1 and block #2 of hyper block #K. For example, the UWB device may perform round hopping only between block #1 of hyper block #K and block #1 of hyper block #K+1.

When using the round hopping method according to an embodiment of the disclosure, the UWB device (or terminal) may know when its next allocated round is (e.g., the block at the same position of the next hyper block). Accordingly, the UWB device (or terminal) may, e.g., enter a hibernation mode and enable power saving.

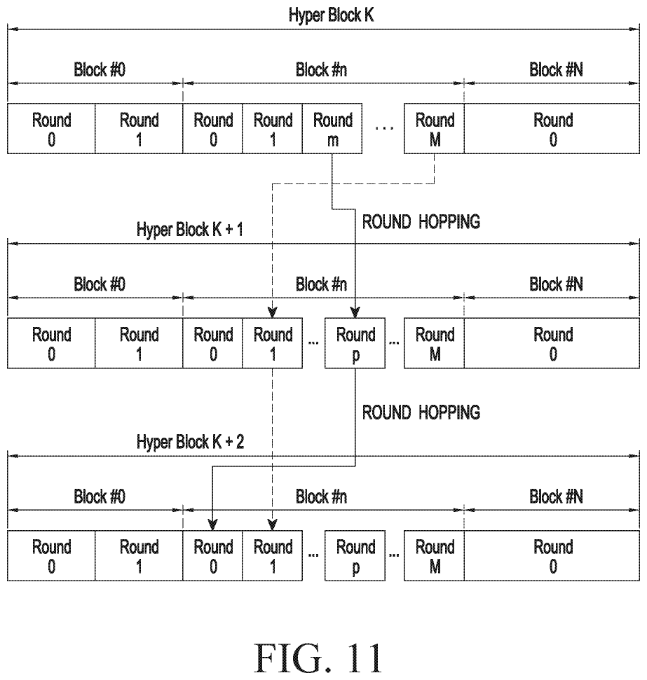

FIG. 11 illustrates an RR IE according to another embodiment of the disclosure.

Referring to FIG. 11, the RR IE may include a Hyper Block Index field, a Ranging Block Index field, a Hopping Mode field, a Round Index field, and a Transmission Offset field.

The Hyper Block Index field may indicate an index of a hyper block where the next allocated block is positioned.

The Ranging Block Index field may indicate an index of a ranging block.

The Hopping Mode field may indicate a hop mode for the ranging block. For example, if the field value is 0, it may indicate no hopping application, and if the field value is 1, it may indicate hopping application.

The Round Index field may specify a ranging round index for the ranging block.

The Transmission Offset field may indicate a transmission offset value of the ranging round within the block in RSTU units. For example, the transmission offset may be a value obtained by subtracting the packet duration from the ranging slot duration.

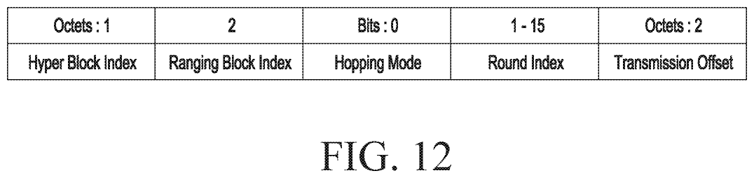

FIG. 12 illustrates an example of round hopping in a hyper block according to another embodiment of the disclosure.

Referring to FIG. 12, hyper block #K may include block #0, block #n, and block #N. According to an embodiment, the duration of each block within hyper block #K may be variously set according to configuration. In hyper block #K, block #0 may include round #0 and round #1, block #n may include round #0, round #1, round #m, . . . , round #M, and block #N may include round #0. According to an embodiment, the duration of each round within each block may be variously set according to configuration.

Adjacent hyper block #K, hyper block #K+1, and hyper block #K+2 may include the same block and/or round structure.

The UWB device may perform round hopping between different rounds within blocks at the same position of adjacent hyper blocks by utilizing the characteristic that the same block structure is repeated in adjacent hyper blocks. According to an embodiment, the UWB device may perform round hopping between different rounds within blocks at the same position of adjacent hyper blocks based on the RR IE illustrated in FIG. 9 or the RR IE illustrated in FIG. 10.

For example, the UWB device may perform round hopping between round #m in block #n of hyper block #K and round #p in block #n of hyper block #K+1. For example, the UWB device may perform round hopping between round #p in block #n of hyper block #K+1 and round #0 in block #n of hyper block #K+2.

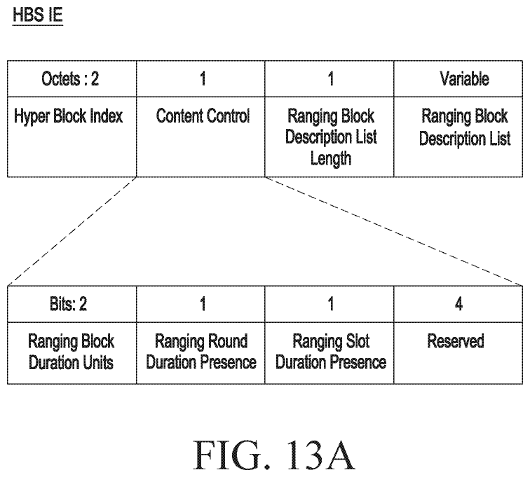

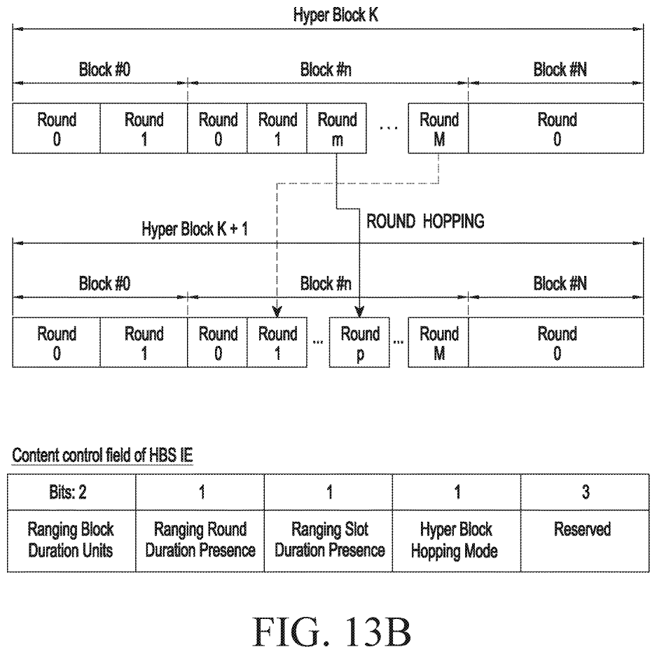

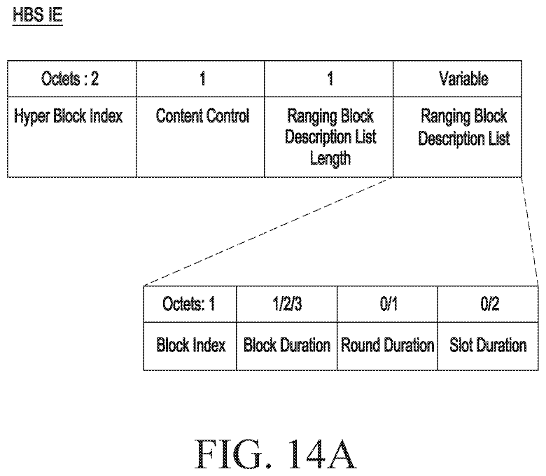

FIG. 13A illustrates an example of a Hyper Block Structure (HBS) IE according to an embodiment of the disclosure.

Although the disclosure describes an HBS IE as an example of an IE for configuring a hyper block structure, the technical spirit of the disclosure is not limited to the HBS IE and may be applied identically or similarly to an IE for configuring a hyper block structure.

Further, the technical spirit of the disclosure is not limited to the names of each field included in the HBS IE, and the names of each field may be implemented in various ways. The technical spirit of the disclosure may be applied to fields indicating the same or substantially the same information as the fields.

Referring to FIG. 13A, the Hyper Block Structure (HBS) IE may include a Hyper Block Index field, a Content Control field, a Ranging Block Description List Length field, and a Ranging Block Description List field.

According to an embodiment, the HBS IE may be included in an RCM message for the controller to deliver the hyper block structure configuration to the controlee.

The Hyper Block Index field may indicate an index of a hyper block.

The Content Control field may include a Ranging Block Duration Units field, a Ranging Round Duration Presence field, a Ranging Slot Duration Presence field, and a Reserved field.

The Ranging Block Duration Units field may indicate the unit of the Block Duration field. The unit of the Block Duration field may be the number of rounds or the number of slots or RSTU. The Ranging Round Duration Presence field may indicate the presence or absence of the Round Duration field. The Ranging Slot Duration Presence field may indicate the presence or absence of the Slot Duration field.

The Ranging Block Description List Length field may indicate the number of Block List elements of the Ranging Block Description List field.

The Ranging Block Description List field may include Block List elements.

FIG. 13B illustrates an example of an HBS IE and round hopping in a hyper block according to an embodiment of the disclosure.

Referring to FIG. 13B, hyper block #K may include block #0, block #n, and block #N. According to an embodiment, the duration of each block within hyper block #K may be variously set according to configuration. In hyper block #K, block #0 may include round #0 and round #1, block #n may include round #0, round #1, round #m, . . . , round #M, and block #N may include round #0. According to an embodiment, the duration of each round within each block may be variously set according to configuration.

Adjacent hyper block #K and hyper block #K+1 may include the same block and/or round structure.

The UWB device may perform round hopping between different rounds within blocks at the same position of adjacent hyper blocks by utilizing the characteristic that the same block structure is repeated in adjacent hyper blocks. For example, the UWB device may perform round hopping between round #m in block #n of hyper block #K and round #p in block #n of hyper block #K+1. For example, the UWB device may perform round hopping between round #M in block #n of hyper block #K and round #1 in block #n of hyper block #K+1.

In FIG. 13B, the Content Control field in the HBS IE may include a Ranging Block Duration Units field, a Ranging Round Duration Presence field, a Ranging Slot Duration Presence field, a Hyper Block Hopping Mode field, and a Reserved field.

Compared to the Content Control field in the HBS IE illustrated in FIG. 13A, the Content Control field in the HBS IE illustrated in FIG. 13B may further include a Hyper Block Hopping Mode field. The description of the remaining fields in the Content Control field in the HBS IE illustrated in FIG. 13B is the same as described above in FIG. 13A.

The Hyper Block Hopping Mode field may be an indicator (or flag) indicating whether Round Hopping is applied. For example, if the Hyper Block Hopping Mode field is 0, it may indicate that round hopping is not applied, and if the Hyper Block Hopping Mode field is 1, it may indicate that round hopping is applied.

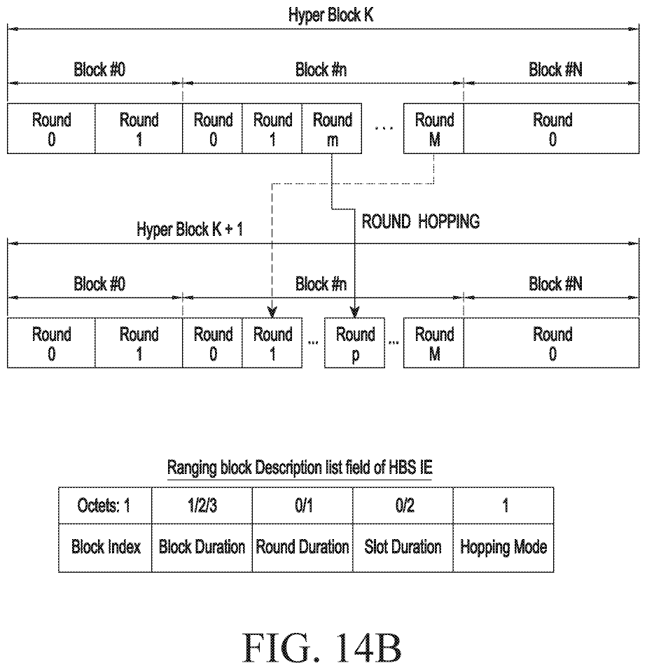

FIG. 14A illustrates an example of an HBS IE according to an embodiment of the disclosure.

Referring to FIG. 14A, the HBS IE may include a Hyper Block Index field, a Content Control field, a Ranging Block Description List Length field, and a Ranging Block Description List field. The description of each field except for the Ranging Block Description List field in the HBS IE illustrated in FIG. 14A is the same as described above in FIG. 13A.

The Ranging Block Description List field may include a Block Index field, a Block Duration field, a Round Duration field, and a Slot Duration field.

The Block Index field may indicate an index of a block within a hyper block. The Block Duration field may indicate the Block Duration. According to an embodiment, the size and unit of the Block Duration field may be determined by the Ranging Block Duration Units field. The Round Duration field may indicate the number of slots per round. The Slot Duration field may indicate the Slot Duration in RSTU units.

FIG. 14B illustrates an example of an HBS IE and round hopping in a hyper block according to an embodiment of the disclosure.

Referring to FIG. 14B, hyper block #K may include block #0, block #n, and block #N. According to an embodiment, the duration of each block within hyper block #K may be variously set according to configuration. In hyper block #K, block #0 may include round #0 and round #1, block #n may include round #0, round #1, round #m, . . . , round #M, and block #N may include round #0. According to an embodiment, the duration of each round within each block may be variously set according to configuration.

Adjacent hyper block #K and hyper block #K+1 may include the same block and/or round structure.

The UWB device may perform round hopping between different rounds within blocks at the same position of adjacent hyper blocks by utilizing the characteristic that the same block structure is repeated in adjacent hyper blocks. For example, the UWB device may perform round hopping between round #m in block #n of hyper block #K and round #p in block #n of hyper block #K+1.

In FIG. 14B, the Ranging Block Description List field in the HBS IE may include a Block Index field, a Block Duration field, a Round Duration field, a Slot Duration field, and a Hopping Mode field.

Compared to the Ranging Block Description List field in the HBS IE illustrated in FIG. 14A, the Ranging Block Description List field in the HBS IE illustrated in FIG. 14B may further include a Hopping Mode field. The description of the remaining fields in the Ranging Block Description List field in the HBS IE illustrated in FIG. 14B is the same as described above in FIG. 14A.

The Hopping Mode field may be an indicator (or flag) indicating whether Round Hopping is applied. The Hopping Mode field may be indicated at an individual block level. For example, if the Hopping Mode field is 0, it may indicate that round hopping is not applied compared to the previous hyper block, and if the Hopping Mode field is 1, it may indicate that round hopping is applied compared to the previous hyper block.

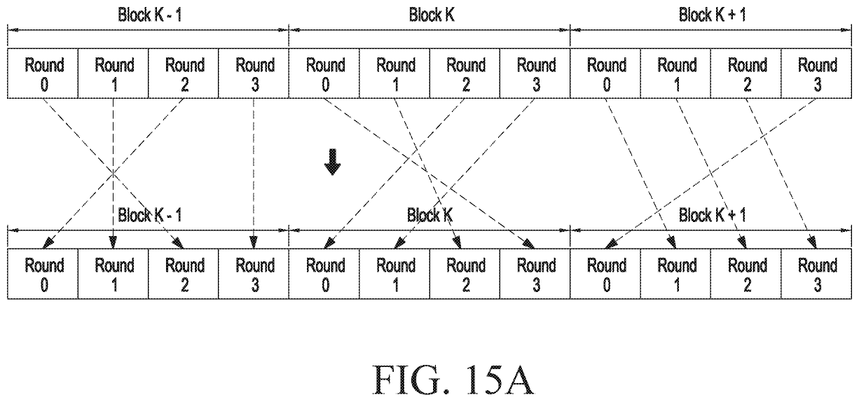

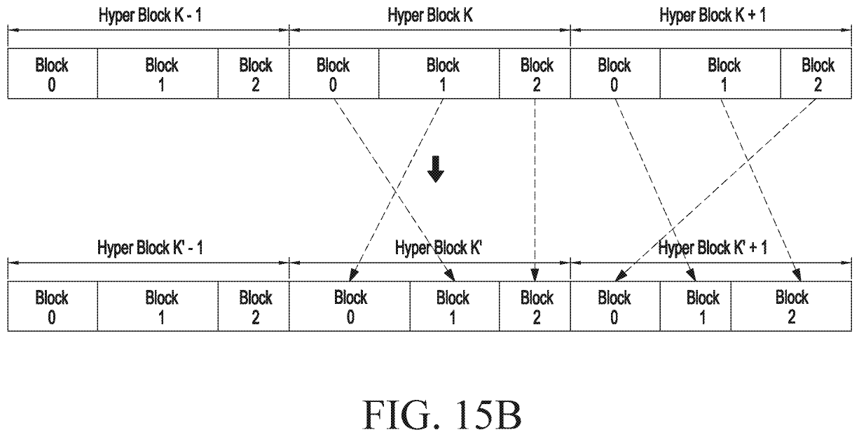

FIG. 15A illustrates an example of round hopping, and FIG. 15B illustrates an example of block hopping according to an embodiment of the disclosure.

Referring to FIG. 15A, a first hyper block may include block #K−1, block #K, and block #K+1. Each of block #K−1, block #K, and block #K+1 within the first hyper block may include round #0, round #1, round #2, and round #3.

A second hyper block may include block #K−1, block #K, and block #K+1. Each of block #K−1, block #K, and block #K+1 within the second hyper block may include round #0, round #1, round #2, and round #3.

For example, the UWB device may perform round hopping between round #0 in block #K of the first hyper block and round #3 in block #K of the second hyper block. For example, the UWB device may perform round hopping between round #1 in block #K of the first hyper block and round #2 in block #K of the second hyper block. For example, the UWB device may perform round hopping between round #2 in block #K of the first hyper block and round #0 in block #K of the second hyper block. For example, the UWB device may perform round hopping between round #3 in block #K of the first hyper block and round #1 in block #K of the second hyper block.

While FIG. 15A illustrates hopping in units of rounds, FIG. 15B illustrates block hopping in units of blocks.

Referring to FIG. 15B, hyper block #K−1 may include block #0, block #1, and block #2, hyper block #K may include block #0, block #1, and block #2, and hyper block #K+1 may include block #0, block #1, and block #2. According to an embodiment, the duration of each of the block #0, the block #1, and the block #2 may be implemented differently.

Hyper block #K′−1 may include block #0, block #1, and block #2, hyper block #K′ may include block #0, block #1, and block #2, and hyper block #K′+1 may include block #0, block #1, and block #2. According to an embodiment, the duration of each of the block #0, the block #1, and the block #2 may be implemented differently.

According to an embodiment, the UWB device may perform block hopping between a first block within a first hyper block and a second block within a second hyper block. The duration of the first block and the second block may be configured identically.

For example, the UWB device may perform block hopping between block #0 in hyper block #K and block #1 in hyper block #K′. For example, the UWB device may perform block hopping between block #1 in hyper block #K and block #0 in hyper block #K′. For example, the UWB device may perform block hopping between block #2 in hyper block #K and block #2 in hyper block #K′.

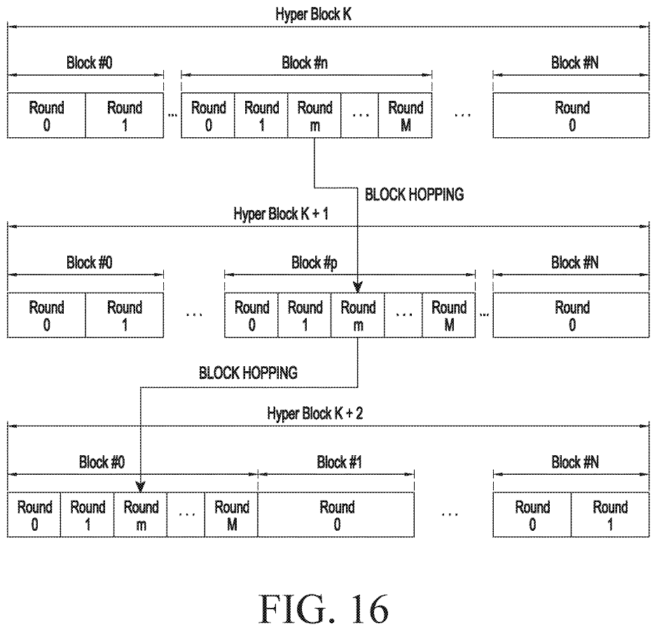

FIG. 16 illustrates another example of block hopping according to an embodiment of the disclosure.

Referring to FIG. 16, hyper block #K may include block #0, . . . , block #n, . . . , block #N, hyper block #K+1 may include block #0, . . . , block #p, . . . , block #N, and hyper block #K+2 may include block #0, block #1, . . . , block #N.

According to an embodiment, the UWB device may perform block hopping between block #n in hyper block #K and block #p in hyper block #K+1. The duration of block #n in hyper block #K and block #p in hyper block #K+1 may be configured identically.

According to an embodiment, the UWB device may perform block hopping between block #p in hyper block #K+1 and block #0 in hyper block #K+2. The duration of block #0 in hyper block #K+2 and block #p in hyper block #K+1 may be configured identically.

In FIG. 16, for illustrative purposes, hopping is shown using round #m included in block #n of hyper block #K and round #m included in block #p of hyper block #K+1, but the technical spirit of the disclosure is not limited thereto. When performing block hopping, the UWB device may perform hopping using a first round (or a plurality of first rounds) included in block #n of hyper block #K and a second round (or a plurality of second rounds) included in block #p of hyper block #K+1.

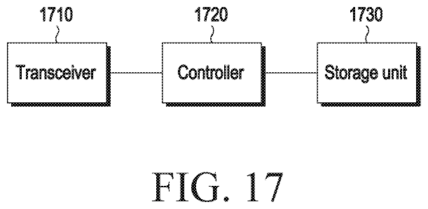

FIG. 17 illustrates a structure of a UWB device according to an embodiment of the disclosure.

In the embodiment of FIG. 17, the UWB device may correspond to the UWB device of FIG. 1, include a UWB device, or may be an electronic device that may include a portion of a UWB device.

Referring to FIG. 17, the UWB device may include a transceiver 1710, a controller 1720, and a storage unit 1730. In the disclosure, the controller may be defined as a circuit or an application-specific integrated circuit or at least one processor.

The transceiver 1710 may transmit/receive messages, information, or packets with another UWB device. The transceiver 1710 may also be referred to as a transceiver or transceiver.

The controller 1720 may control the overall operation of the UWB device according to embodiments proposed in the disclosure. Specifically, the controller 1720 may control the operations of the UWB device described above with reference to FIGS. 1 to 16.

The storage unit 1730 may store at least one of information transmitted and received through the transceiver 1710 and information generated through the controller 1720. For example, the storage unit 1730 may store information and data necessary for the method described above with reference to FIGS. 1 to 16.

According to an embodiment, the controller 1720 may generate a control message including an index of a ranging round, an offset of the ranging round, and an index of a hyper block. According to an embodiment, the controller 1720 may control to transmit the control message to another UWB device. According to an embodiment, the controller 1720 may perform round hopping between ranging rounds based on the index of the hyper block.

According to an embodiment, the index of the hyper block may be indicated by a ranging block index field included in a ranging round (RR) IE.

According to an embodiment, the index of the hyper block may be indicated by a hyper block index field included in a ranging round (RR) IE.

According to an embodiment, the control message may be a ranging control message (RCM) defining ranging features.

According to an embodiment, the controller 1720 may perform round hopping between a first ranging round included in a first ranging block of a first hyper block and a second ranging round included in a second ranging block of a second hyper block. The first ranging block and the second ranging block may be configured with the same duration.

According to an embodiment, the controller 1720 may generate a control message including configuration information for a hyper block structure and an indicator regarding whether round hopping is applied. According to an embodiment, the controller 1720 may control to transmit the control message to a second UWB device. According to an embodiment, the controller 1720 may perform round hopping between ranging rounds based on the indicator regarding whether round hopping is applied.

According to an embodiment, the indicator regarding whether round hopping is applied may be included in a Content Control field of a Hyper Block Structure (HBS) IE.

According to an embodiment, the indicator regarding whether round hopping is applied may be included in a Ranging Block Description List field of a Hyper Block Structure (HBS) IE.

According to an embodiment, the control message may be a ranging control message (RCM) defining ranging features.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method of a first ultra-wideband (UWB) device supporting a hyper block including at least one ranging block, the method comprising:
generating a ranging round (RR) IE including an index field of a ranging block, a hopping mode field indicating a hop mode for the ranging block, an index field of a ranging round for the ranging block, and a transmission offset field of the ranging round; and
transmitting a control message including the RR IE to a second UWB device, wherein in a hyper block-based mode, the index field of the ranging block indicates an index of a hyper block.

2. The method of claim 1, wherein in a block-based mode, the index field of the ranging block indicates an index of the ranging block.

3. The method of claim 1, wherein the control message is a ranging control message (RCM) defining ranging features.

4. The method of claim 1, comprising performing round hopping between a first ranging round included in a first ranging block of a first hyper block and a second ranging round included in a second ranging block of a second hyper block, wherein the second hyper block is a block immediately following the first hyper block, and wherein the first ranging block and the second ranging block are at the same position within each hyper block.

5. A method of a first ultra-wideband (UWB) device supporting a hyper block including at least one ranging block, the method comprising:
generating a control message including configuration information for a hyper block structure and an indicator regarding whether round hopping is applied;
transmitting the control message to a second UWB device; and
performing round hopping between ranging rounds based on the indicator regarding whether round hopping is applied.

6. The method of claim 5, wherein the indicator regarding whether round hopping is applied is included in a field regarding content of an IE regarding a hyper block.

7. The method of claim 5, wherein the indicator regarding whether round hopping is applied is included in a field regarding configuration of a ranging block of an IE regarding a hyper block.

8. The method of claim 5, wherein the control message is a ranging control message (RCM) defining ranging features.

9. The method of claim 6, comprising performing round hopping between a first ranging round included in a first ranging block of a first hyper block and a second ranging round included in a second ranging block of a second hyper block, wherein the second hyper block is a block immediately following the first hyper block, and wherein the first ranging block and the second ranging block are at the same position within each hyper block.

10. A first ultra-wideband (UWB) device supporting a hyper block including at least one ranging block, the first UWB device comprising:
a transceiver; and
a controller configured to:
generate a ranging round (RR) IE including an index field of a ranging block, a hopping mode field indicating a hop mode for the ranging block, an index field of a ranging round for the ranging block, and a transmission offset field of the ranging round, and
control to transmit a control message including the RR IE to a second UWB device, wherein in a hyper block-based mode, the index field of the ranging block indicates an index of a hyper block.

11. The first UWB device of claim 10, wherein in a block-based mode, the index field of the ranging block indicates an index of the ranging block.

12. The first UWB device of claim 10, wherein the control message is a ranging control message (RCM) defining ranging features.

13. The first UWB device of claim 10,
wherein the controller is configured to perform round hopping between a first ranging round included in a first ranging block of a first hyper block and a second ranging round included in a second ranging block of a second hyper block, wherein the second hyper block is a block immediately following the first hyper block, and
wherein the first ranging block and the second ranging block are at the same position within each hyper block.

14. A first ultra-wideband (UWB) device supporting a hyper block including at least one ranging block, the first UWB device comprising:
a transceiver; and
a controller configured to:
generate a control message including configuration information for a hyper block structure and an indicator regarding whether round hopping is applied,
control to transmit the control message to a second UWB device, and
perform round hopping between ranging rounds based on the indicator regarding whether round hopping is applied.

15. The first UWB device of claim 14, wherein the control message is a ranging control message (RCM) defining ranging features.
